(19) United States
(12) Patent Application Publication
(10) Pub. No.: US 2002/0036276 A1
(43) Pub. Date: Mar. 28, 2002

(54) Method and apparatus for monitoring the characteristics of a fluid

(76) Inventor: Daniel J. Seeman, Charlotte, NC (US)

Correspondence Address: DOUGHERTY & CLEMENTS, TWO FAIRVIEW CENTER, 6230 FAIRVIEW ROAD, SUITE 400, CHARLOTTE, NC, 28210, US

(21) Appl. No.: 09/923,817

(22) Filed: Aug. 7, 2001

Related U.S. Application Data
(60) Provisional application No. 60/223,149, filed on Aug. 7, 2000.

(51) Int. Cl. G01N 21/00

(52) U.S. Cl. 250/573; 340/603

(57) ABSTRACT

An in-line sensor apparatus and method for the control of fluid manufacture, especially the manufacture of carbonated beverages, provides precise and reliable monitoring of several characteristics of the material of interest. The apparatus consists of a sensor head that is mounted at a point in the process where control is needed. A controlled wavelength light is directed toward the fluid being monitored. The light is sensed directly and after passing through the fluid. Sensor data is processed into reference and quality signals. Fluid quality is predicted by processing these signals.

### CROSS-REFERENCE TO RELATED APPLICATION

This application claims the benefit of U.S. Provisional Application No. 60/223,149, filed Aug. 7, 2000.

### FIELD OF THE INVENTION

This invention relates to in-line process monitoring systems in which the in-line process involves fluid mixing in a system of valves, tanks and piping. The in-line process may involve multiple fluid products. The invented process monitoring system extracts fluid characteristics by electronically measuring optical properties of the fluid continuously. Such in-line process monitoring systems are needed to maintain quality levels of the fluid product and to monitor and reduce waste during process change over from one specific product to another. A significant application of this invention and example of an in-line fluid processing system is carbonated beverage bottling.

### BACKGROUND OF THE INVENTION

The beverage bottling process can be described as mixing three components together; water, sugar, and concentrate; or water, synthetic dietetic sweeteners and concentrate, to form a syrup; then mixing water and syrup, and, typically, adding CO₂ to the mixture. Finally, the beverage is bottled or canned. Sometimes, CO₂ is not used. Then, other ingredients may replace CO₂ such as nitrogen.

The quality control of beverages is a multifaceted endeavor that may include physical metrology and actual tasting of a product by experts. The concern of this invention is physical metrology and particularly on-line quality measurements. While taste-testing is the ultimate criterion, an unsatisfactory quantity of unrecoverable reject product will flow through a typical bottling plant before such an ultimate taste test can produce results than can be used to effect corrections. Physical tests cannot replace more expert tests but are needed to achieve timely quality control.

Note that the specific numbers that follow are provided for pedagologic purposes and do not represent actual formulations. For this patent application, they are completely reliable.

TABLE 1
Hypothetic Beverage Formulae

| | | Test Beverage - Synthetic | |
|---|---|---|---|
| Test Beverage - Sugar | | Sweeteners | |
| H₂O | 91.333% | H₂O | 99.133% |
| Sucrose | 8.000% | Aspartame | 0.200% |
| Concentrate | 0.666% | Concentrate | 0.666% |
| Beverage in a | 100.000% | Diet Beverage in a | 100.000% |
| Bottle | | Bottle | |

From the viewpoint of physical metrology, the quality of the beverage is determined by the syrup-to water ratio and the CO₂ content. In bottling plants today, a bottle or can is usually brought off-line to a laboratory to check the product for the Brix and CO₂ content. Brix is the non-carbonated fluid. The Brix Saccharometer scale shows directly the per cent of sucrose by weight at a given temperature, usually 17.4° C. The typical instruments used are either a densitometer or a refractometer. Both instruments measure the per cent of sugar present, by weight or by refraction, respectively. Adjustments are made if the product does not meet specifications. However, if something goes wrong between spot checks, an economically significant quantity of unusable product can be bottled, canned, or placed in the tanks ahead of the final packing part of the production line. To quantify the problem faced in developing an effective in-line tool, the following analysis is provided. The density numbers are in units of pounds per gallon throughout. In this system of units, the density of pure water is 8.346 (the equivalent of one gram per cubic centimeter). Typical plant water density is 8.334.

Table 2 illustrates the difficulty faced by the developer. Syrup A is the desired syrup that will later be mixed with water to form Brix. The concentrate represents the mixture of materials that imparts the specific flavor of the beverage. Syrups B, C and D are dramatically incorrect cases in which there is no concentrate at all. The examples differ in the manner in which the concentrate has been supplanted. Never does the density vary by as much as 2%.

TABLE 2
Sucrose-sweetened syrups

| | COM- | | | | |
|---|---|---|---|---|---|
| COM- | PONENT | | | | |
| PONENT | DENSITY | SYRUP A | SYRUP B | SYRUP C | SYRUP D |
| Sucrose | 10.610 | 48% | 52% | 48% | 50% |
| Concen- | 10.730 | 4% | 0% | 0% | 0% |
| trate | | | | | |
| Water | 8.334 | 48% | 48% | 52% | 50% |
| Density | | 9.522 | 9.517 | 9.426 | 9.472 |
| Density, | | 100.0000% | 99.9496% | 98.9935% | 99.4716% |
| % Ref. | | | | | |

TABLE 3
Brix

| | COM- | | | | |
|---|---|---|---|---|---|
| COM- | PONENT | | | | |
| PONENT | DENSITY | CASE 1 | CASE 2 | CASE 3 | CASE 4 |
| Water | 8.334 | 83.33% | 83.33% | 83.33% | 83.33% |
| Syrup A | 9.522 | 16.67% | 0.00% | 0.00% | 0.00% |
| Syrup B | 9.517 | 0.00% | 16.67% | 0.00% | 0.00% |
| Syrup C | 9.426 | 0.00% | 0.00% | 0.00% | 16.67% |
| Syrup D | 9.472 | 0.00% | 0.00% | 16.67% | 0.00% |
| Density | | 8.5317 | 8.5312 | 8.5237 | 8.5160 |
| Density % | | 100.0000% | 99.9941% | 99.9062% | 99.8160% |
| Desired | | | | | |

Clearly, an in-line densitometer would need greater than 99.999% precision in a syrup line and greater than 99.9999% precision in a Brix line to have any hope of sorting a good product from bad.

Next, considering diet beverages, we find:

TABLE 4
Artificially-sweetened syrups

| | COMPONENT | | |
|---|---|---|---|
| COMPONENT | DENSITY | Syrup B | Syrup F |
| Water | 8.3340 | 95.20% | 99.20% |
| Concentrate | 10.7500 | 4.00% | 0.00% |
| Diet Sweetener | 9.0000 | 0.80% | 0.80% |
| Syrup Density | | 8.4360 | 8.3396 |
| Density, % Ref. | | 100.0000% | 98.8573% |

TABLE 5
Titratable Acidity

| | COMPONENT | | |
|---|---|---|---|
| COMPONENT | DENSITY | CASE 5 | CASE 6 |
| Water | 8.3340 | 83.30% | 83.30% |
| Syrup E | 8.4360 | 16.70% | |
| Syrup F | 8.3396 | | 16.70% |
| Product Density | | 8.3510 | 8.3349 |
| Product Density referenced to | | 100.0000% | 99.8080% |
| desired case | | | |

Clearly, an in-line densitometer would need better than 99.99% precision in a syrup line and better than 99.999% precision in Titratable Acidity (diet equivalent of Brix) line to have any hope of sorting a good product from bad. This is better than the sucrose product but nonetheless unrealistic. The testing of Titratable Acidity is confounded by interaction with plant water pH, sometimes leading to inappropriate remedial actions. For example, the ratio of water to concentrate may be varied instead of correctly adjusting the pH of the plant water.

Refractometers and densitometers can precisely measure the sucrose content of the product but do not, nor are they able to, reliably measure the concentrate level, and these instruments are useless in quality checking any diet product properties. Brix may also be measured by a polarimeter since the rotation of polarized light depends on the Brix value.

### DESCRIPTION OF RELATED ART

Electronic monitoring systems for in-line processes are widely available. The last forty years have witnessed emergence of computer-aided design (CAD), computer aided engineering (CAE), and computer aided manufacturing (CAM). CAM uses a model of a process step in manufacturing and in-line sensors to assess whether a process at any given moment is operating within limits. The model may be derived empirically or theoretically. The sensors function in almost any imaginable fashion. Typical examples include thermal sensors, dimensional sensors, surface roughness sensors, and many more. CAM is easily justified in hostile environments where using direct manufacturing staff is undesirable for safety or comfort. Such systems have often presented CAM designers with the need to sense desired characteristic in the presence of noise. Sophisticated systems have been developed to operate CAM systems in these situations reliably. In fluid in-process systems, sensors exist to monitor the fluid viscosity, flow-rate and so forth. Optical properties of fluids have proved useful in some circumstances. For example the Schlieren optical test technique converts a shift in indexes of refraction to an easily measured change in radiance. Since this relationship is also temperature sensitive, the radiance must be calibrated for temperature measured independently. The variations in percent by weight of sugar in water varies the rotation angle of light. Measurement systems have been designed to sense this angle, providing a means to monitor this aspect of a typical in-line process fluid. Sometimes the sensors are electromechanical. For example, viscosity is sometimes measured by measuring the energy needed to turn a vane immersed in the fluid. A rotation angle is sometimes measured by illuminating the fluid-under-test with light passed through a rotating polarizer that converts a rotation angle to radiance.

Computer-processed sensor data is used in two ways. The processed data may be displayed in some meaningful manner on a process operator's console. The operator continually views a presentation of this data from multiple sensor points in the process and upon detecting unacceptable deviation from a standard, takes remedial action. In other systems, the processed sensor data forms part of a servomechanism and the process is maintained in specification automatically. A common set of hardware exists in all sensor subsystems. The sensor eventually produces a voltage, current or other equivalent parameter that varies with the physical attribute sensed. The voltage is amplified and noise is managed for example by filtering or subtracting a reference known to vary with the noise but lacking a signal. The extracted signal is converted to a digital data stream by an analog to digital converter. The data stream then undergoes data processing to effect a display for the process operator or to effect a direct modification to the process in the servomechanism case.

Although a large body of technology exists for monitoring in-line fluid processes, the need still exists for a monitoring apparatus that precisely and reliably tracks various characteristics of such a process in a cost-effective way. What is needed in the beverage industry is a precise and reproducible in-line measurement technique that responds to a fault within one minute of the appearance of an out-of-specification product. The in-line monitor should produce correct remedial actions more reliably than the present systems that are unable to parse concentrate ratio issues from plant water pH issues. The in-line monitor should be useful in all stages of production, for both sucrose and diet beverages, including carbonated and non-carbonated beverages.

### SUMMARY OF THE INVENTION

The invention consists of an in-line sensor apparatus and a method for the control of fluid manufacture, especially the manufacture of carbonated beverages that provides precise and reliable monitoring of several characteristics of the material of interest. The apparatus consists of a sensor head that is mounted at points in the process where control is needed. The sensor head preferably consists of a tee-shaped section of pipe. The fluid-under-test passes through one arm of the tee. The orthogonal arm of the tee contains sight glass ports mounted in opposing flanges by which light can be introduced a one slight glass, pass through the fluid-under-test and be sensed and analyzed by appropriate components at the other sight glass. Properties of the fluid-under-test can be monitored in real time without interfering with the fluid in any way. In a first embodiment, the apparatus contains no moving parts and uses a specific and precise single wavelength of light. Processed data from the apparatus may be characterized in the operatively attached computer system to permit multiple products to be controlled which is a key requirement for carbonated beverage bottlers. It has been shown that data from this device correlates with multiple physical properties such as color, chemical composition, density, viscosity and opacity. Some of these properties have been elusive to conventional metrology, especially the level of concentrate present in the fluid. The invented apparatus and method develop a signature for each material based on the wavelength of the light that passes through the fluid being monitored. This signature has proved more effective in quality control of these materials than conventional metrology for density, or for acidity.

Although the precision that has been empirically determined for the first embodiment is practical, the calibration frequency may depend upon the precision with which light sensors track. The observed, required precision suggests that sometimes, particularly in monitoring Brix, calibration frequency may be advantageously reduced by using a single light-sensor obviating the concern. In a second embodiment, light from the fluid being monitored and reference light is alternately directed to a single light sensor and subsequently amplified, converted to a digital data stream and processed by an on-line computer.

A variation on either embodiment has a provision to illuminate the fluid being monitored at a plurality of specific wavelengths rather than a single specific wavelength at each monitoring station. This variation permits cross-checking a decision made at a first wavelength by a corresponding decision at a second wavelength. The apparatus is capable of extension to multiple wavelengths.

### OBJECT OF THE INVENTION

The object of the invention is to provide a apparatus and method for the monitoring of fluids in an in-line processing plant for such fluid, for example carbonated beverage bottling, that captures sufficient salient data concerning qualities of the fluid for control of the quality of the fluid.

### BRIEF DESCRIPTION OF THE DRAWINGS

The foregoing and other objects will become more readily apparent by referring to the following detailed description and the appended drawing in which:

FIG. 1 is a schematic diagram of the monitoring apparatus of the invention;

FIG. 2 is a partially representational mechanical schematic illustration of some principal components of the invention;

FIG. 3 is a functional schematic diagram of the monitoring apparatus of the invention;

FIG. 4 is schematic diagram of a beverage bottling plant incorporating monitoring systems according to the invention;

FIG. 5 is a schematic diagram of a detail of an alternative embodiment of a monitoring system.

FIG. 6 is a schematic diagram of further details of an alternative embodiment;

FIG. 7 is a partial sideview of further details of an alternative embodiment,

FIG. 8 is a schematic representation of a method of introducing multiple, independent, precise wavelengths of light, and

FIG. 9 is a simplified schematic diagram of the basic system of the invention.

### DETAILED DESCRIPTION

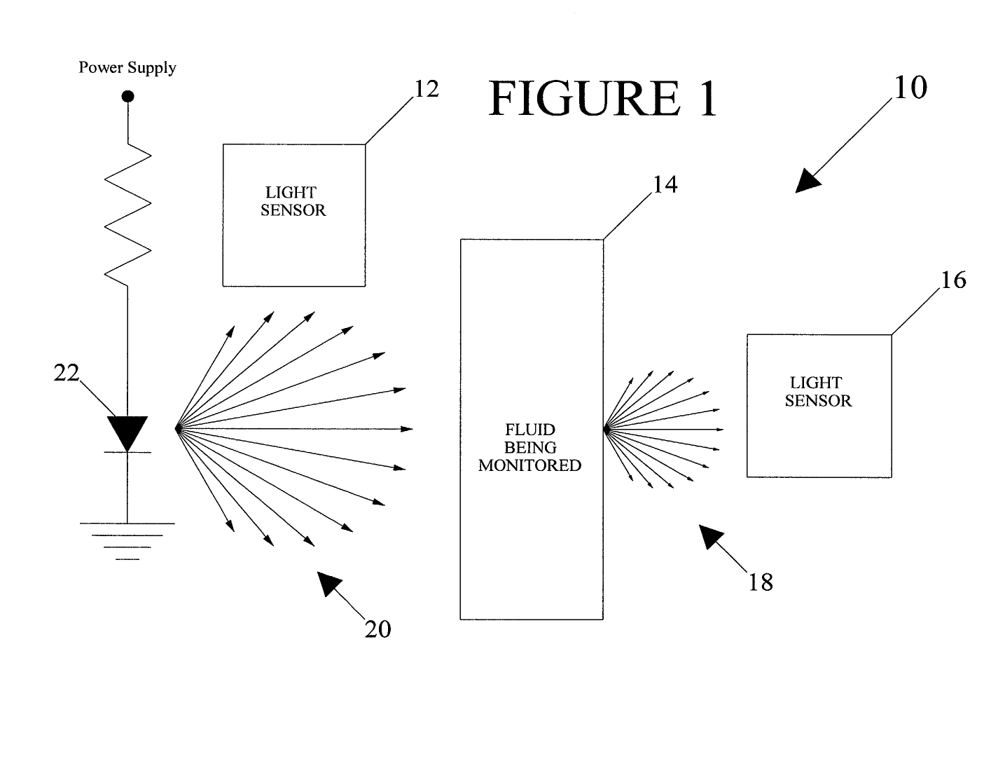

FIG. 1 presents a schematic diagram of the invention. The invented apparatus 10 consists of a light source 22 that illuminates the fluid being monitored 14. A portion of the light 20 that is independent of the fluid being monitored illuminates light sensor 12. Light sensor 12 output is converted to the reference signal and monitored to ensure that the light source 20 is stable. Light that passes through the fluid being monitored 18 depends on the characteristics of the fluid. The light 18 illuminates light sensor 16. Light sensor 16 output is converted to the reference signal and calibrated with a known conforming fluid. The reference signal is continuously compared to calibration values to ensure the quality of the fluid being monitored.

There are many viable choices for light source 22. Table 6 lists some broad categories of light-emitting diodes. It will be recognized by those skilled in the art that other specifications may also be critical. Output power is generally specified in milliwatts per milliamp into a specified measurement situation.

TABLE 6
LED Options

| Material | Wavelength (nm) |
|---|---|
| GaP | 565 |
| GaAsP | 590 |
| GaAsP | 632 |
| GaAsP | 649 |
| GaAlAs | 850 |
| GaAs | 940 |
| InGaAs | 1060 |
| InGaAsP | 1300 |
| InGaAsP | 1550 |

These LED materials span the range from green to near infrared. Depending on the fluid being monitored and the salience of various characteristics, one of these diodes may be selected as the light source 22. In a first embodiment, a single LED is the preferred light source, other embodiments commute between a plurality of light sources of differing wavelengths.

The light sensors 12 and 16 may be realized in several technologies. Most light sensors have a fixed entrance pupil. Photodiodes, phototransistors, photosensitive integrated circuits and vacuum-based photosensors are known in the art. Each of these technologies have attendant properties which affect the engineering of the solution. Typically, these technologies generate a current that is linearly related to the irradiance on the entrance pupil. Depending on the task, variation from device to device and confounding of irradiance-based current and thermal current may be a problem. One example of a photosensitive integrated circuit is a light to frequency converter, such as, Texas Instruments TSL235®. This device is not a unique solution, but is a convenient solution for the instant invention. The device has the following properties:

$${f}_{O} = {C}_{1} \times E + {C}_{0}$$

$$\text{Where}$$

$$\begin{matrix}{f}_{O} = the output frequency in kHz , \\ {C}_{1} = \frac{0.67 \pm 0.13 kHz}{μ W / {cm}^{2}} in kHz , \\ {C}_{0} = 0.007 kHz\end{matrix}$$

E=the irradiance on the 1.36 mm² photodiode area in μW/cm². The converter exhibits substantial offset (±0.13 kHz), but a very low zero crossing and excellent linearity (±0.2%). Thermal drift affects the C₀ term and is negligible if sufficient light is used.

In order to use the output, the frequency must be measured. The choice of interface and measurement technique depends on the desired resolution and data-acquisition rate. For maximum data-acquisition rate, period-measurement techniques are used.

Period measurement requires the use of a fast reference clock with available resolution directly related to reference-clock rate. The technique is employed to measure rapidly varying light levels or to make a fast measurement of a constant light source. In the case of fluid monitoring, the variation rate of interest is low relative to the typical output frequency which exceeds 25 kHz. Change rates of interest in beverage bottling are on the order of 1 Hz. Period measurement is neither necessary nor optimum.

Maximum resolution and accuracy may be obtained using frequency-measurement, pulse-accumulation, or integration techniques. Frequency measurements provide the added benefit of averaging out random- or high-frequency variations (jitter) resulting from noise in the light signal. Resolution is limited mainly by available counter registers and allowable measurement time. Frequency measurement is the method of choice in beverage bottling since frequency measurement is well suited for slowly varying light levels and for reading average light levels over short periods of time. Integration, the accumulation of pulses over a very long period of time (seconds), can be used to measure exposure; the amount of light present in an area over a given time period is the other extreme and is generally not appropriate in beverage bottling.

Since the factors that effect the irradiance at the sensor, absorption, scattering and polarization, act as a multiplier to the input light, the following method is preferred to process the data for decision-making, although this is not the only method that may succeed. A quality signal is derived is from the light that passes through the fluid 14 and is characteristic thereof and is sensed by sensor 16. An upper limit for the quality signal, \overline{Q}₀ is established with a known conforming fluid in the pipe. Similarly, a lower limit for the quality signal, Q₀ is established with a known conforming fluid in the pipe. The value of the reference signal R₀, based on the irradiance that is independent of the fluid and sensed by light sensor 12, is recorded at that same calibration time. As the process runs, a sequence of reference signals that are independent of the fluid are generated: R₁R₂, . . . R₁, . . . from light sensor 12. Ideally, these signals are equal. Steps may be taken to minimize the variation. For example, it is known in the art to arrange that the current through the photodiode is substantially independent of power supply level by using a special low drift voltage (a battery, for example), a low drift resistor and an operational amplifier. With such a technique, radiance drift with power and temperature may be reduced by many orders of magnitude. Since the hallmark of this invention is precision, it is important to renormalize the raw quality numbers to account for multiplicative error, even if the error is minimized. The quality signal can be thought of as a multiplier of the reference, namely Qᵢ=Fᵢ(Fluid)×Rᵢ. As the process runs, a sequence of quality signals Q₁, Q₂, . . . , Qᵢ, . . . are generated, each with a signature of the fluid present. To control the process, each quality signal must be normalized to find the right signal to compare with \overline{Q}₀ and Q₀. What is needed is Qⁱᵢ=Fᵢ(Fluid)×R₀ when Rᵢ+R₀. This normalization is easily accomplished.

$${Q}_{i}^{′} = {F}_{i} ( Fluid ) \times [ 1 - \frac{{R}_{i} - {R}_{0}}{{R}_{i}} ] \times {Q}_{i}$$

The calculation form above is convenient for checking each value of R₁ for excessive deviation. The quantity |(R₁−R₀)/Rᵢ| should be less than a predetermined value, for example, 0. 1.

In beverage bottling, the change from the lower limit to the higher limit is typically less than 5% of the average value. Thus, in beverage applications, negligible error is made by assuming linearity. Even if the underlying process were nonlinear, the process can be treated as linear over such a small range. In other applications, linearity may not be a valid assumption. Clearly, control of fluids with a greater relative acceptance range may benefit from a mathematical transformation of the set of quality signals to linearize them.

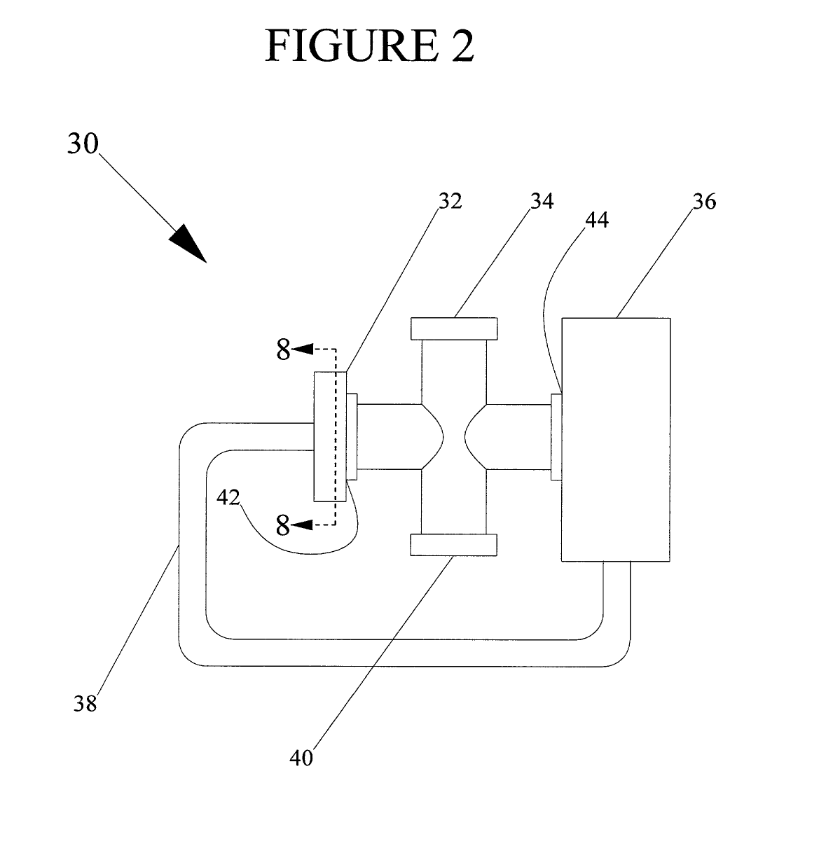

FIG. 2 is a mechanical schematic 30 of the invented monitor. In a bottling plant, fluids flow through pipes. A typical pipe with a fluid of interest is interrupted by a tee-shaped member. The fluid enters the member at the top 34 and exits at the bottom 40. The cross members are fitted with sight glasses, windows that are substantially transparent to the wavelengths of light used as light source 22. The input sight glass 42 is on the left, the output 44 is on the right. The input housing 32 contains the light source 22 and the light sensor 12 that is independent of the fluid. When a light to frequency converter is used for light sensor 12, the cable 38 contains one power lead and one signal lead coaxial to a grounded duct. The housing and duct are preferably thermally conductive so that thermal differentials between the left and right housings are minimum. Right-hand housing 36 contains dependent light sensor 16 and either a computer interface or circuitry to perform the monitoring of the reference signal and the quality signal.

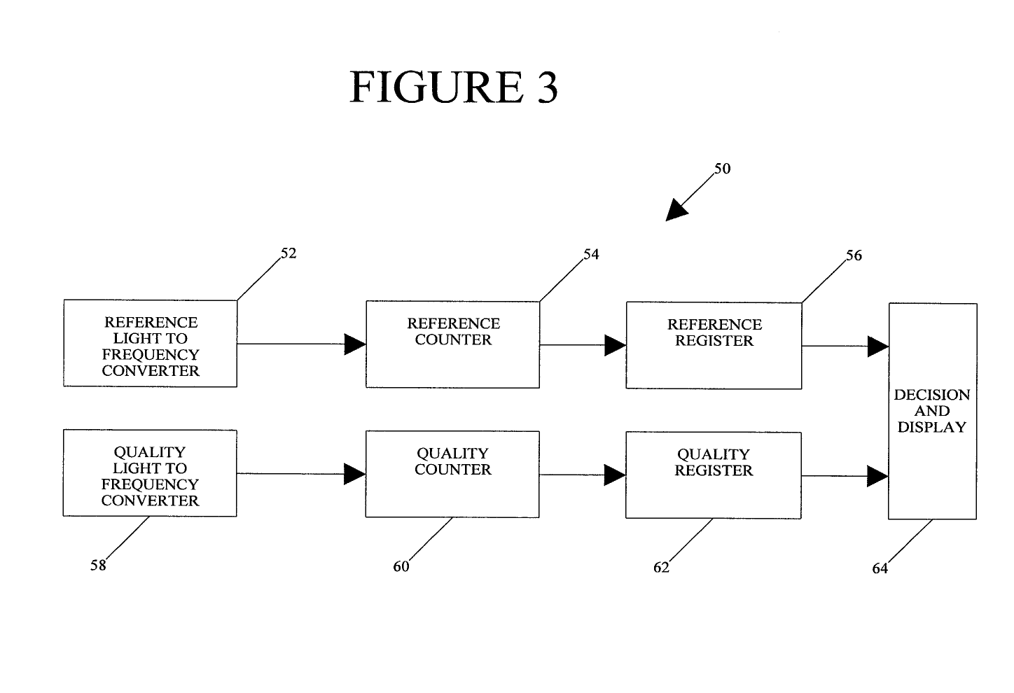

FIG. 3 is a functional schematic of the apparatus of this invention. The previously discussed light-to-frequency converters such as Texas Instrument's TSL235® are used to implement the reference light sensor 12 and the quality light sensor 16 are shown in functional blocks 52 and 58 respectively. The first step in converting the information-containing frequency to a signal for further processing is to quantify the frequency. This is accomplished using a counter. As previously explained, if high speed were an issue, the pulse width could be measured. While that would be an operative possibility, the dynamics of fluid-monitoring in a bottling plant are best served by simply counting pulses over a sufficient time. The reference counter 54 is reset periodically and then counts pulses from the light-to-frequency converter until that period times out. The count standing in the counter at time-out is transferred in parallel to a reference register 56. Thus, a sequence of reference signals are generated, one signal at each transfer. When the system is calibrated, the calibration reference count is saved in the decision and display module 64 which may be implemented in a personal computer. The precision of the system depends on the average count and the period over which pulses are counted. For example, if the converter operates at a typical frequency of 50 kHz and the counting period is 500 ms, the precision is 1:25000. If a computer is not used for decision and display 64, a fifteen bit binary counter would hold the reference signal. If a computer is used, a more convenient counter length may be selected and a running average constructed in software. A predetermined drift that depends on the overall engineering design is constructed around this reference calibration level. For example, an upper limit might be 25050 counts and a lower limit might be 24950 counts. An alert signal is generated if the reference signal is not contained in these bounds. A shift in the power supply level might be sufficient to generate a reference alert signal. If a computer is not used, the quantity of light can be obtained with an analog integrator rather than a counter and the signal generated thereby, processed with analog comparators.

Continuing to refer to FIG. 3, the quality signal is established in a parallel fashion. The quality counter 60 is reset periodically and then counts pulses from the light-to-frequency converter until that period times out. The count standing in the counter at time-out is transferred in parallel to a reference register 62. Thus, a sequence of quality signals is generated, one signal at each transfer. The system is calibrated with a fluid that is known to be conforming to specification, the calibration quality count is saved in the decision and display module 64 which may be implemented in a personal computer. An upper limit and lower limit (of quality count) are established at calibration time. These limits may be established empirically if extreme cases of fluid are available at initial calibration. The limits may be derived partially from historical data. A light to frequency converter has excellent precision, low drift, excellent insensitivity to variations in power supply level, but it can exhibit substantial offset. In general, the counts needed for each type of fluid may be unique to a specific light-to-frequency converter. If a computer is used, the quality signal may be continuously displayed on the computer screen as a dynamic but otherwise conventional quality control chart. Typical count ranges are from 1.5% to about 4% in a beverage bottling plant. If the system is calibrated at a center value of about 25000 counts, an error of about 35 counts can be tolerated.

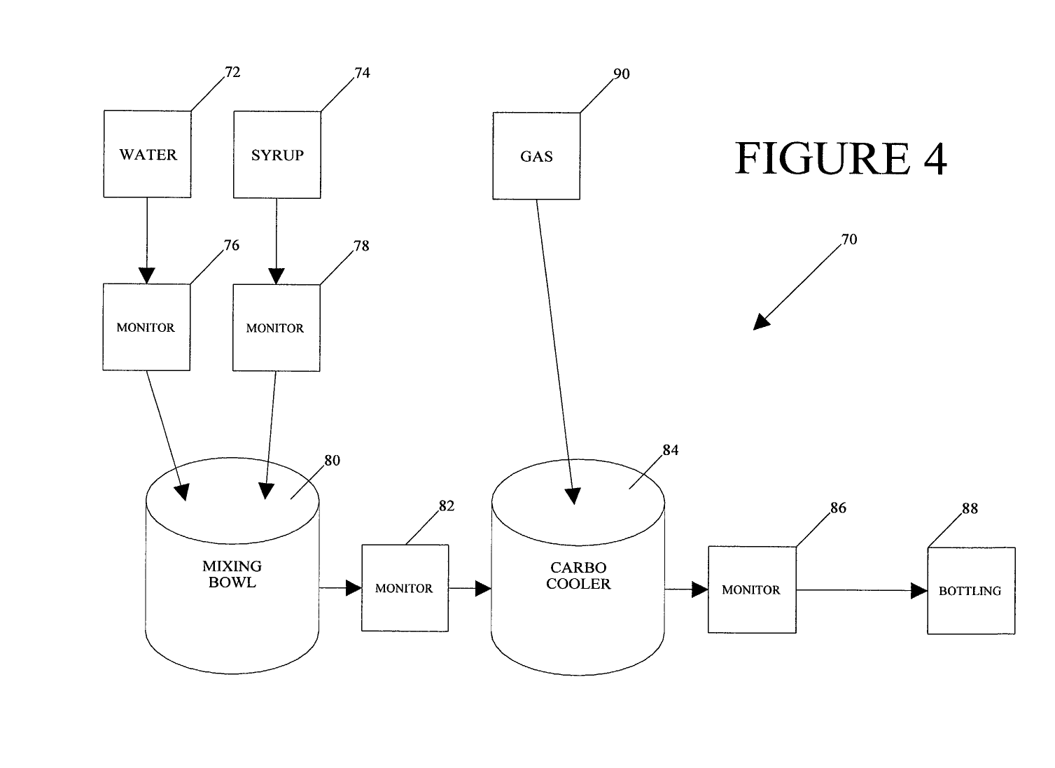

FIG. 4 shows a schematic diagram of a bottling plant with fluid monitors incorporated therein according to this invention. The bottling plant 70 consists of a first operation wherein plant water 72 and syrup 74 are monitored with monitors 76 and 78 respectively. Syrup 74 may be Brix or diet. An advantage of the invented method is that a monitored process, using historic calibration data can effect rapid changeover from one product to another. Plant water is not pure water but varies in the content of various salts and pH. While it is unlikely that quality signal generated by the plant water will trigger an alert signal, the quality signal from the plant water is used to modify the quality limits at for the quality signal of the mixture of water and syrup 82. This interaction is especially significant for diet products. The syrup 74 is monitored 78. The quality signal from this monitor is also used to modify the quality limits for quality signal 82. The syrup and water are mixed in mixing bowl 80. The quality signal after mixing tracks the sum of the quality signal of the water and syrup. The mixture can sometimes be heterogeneous. False alerts can be triggered if the counting period or equivalent running average is so short that fluctuations that are the result of incomplete mixing are sensed. Thus, the integration period or counter period must be appropriate to the expected mixture. The mixture enters the carbo-cooler 84 where CO₂ or equivalent gas 90 is introduced. The final product is monitored 86 and bottled 88. The limits for the quality signal at monitor 86 depend on the quality signal at monitor 82. Experimental plant operation according to this invention concluded that the invented method can both prevent catastrophic failures (bottling waste) and maintain product production with the guidelines of each product. Referring to Table 7, the above method and apparatus have been applied to the beverage bottling requirements and typical results are given.

TABLE 7
Typical Results Quality Signals

| | | | Titratable |
|---|---|---|---|
| | Brix | CO₂ | Acidity |
| High Limit | 11.6 | 3.84 | 26.56 |
| Low Limit | 11.4 | 3.69 | 26.03 |
| Range | 0.2 | 0.15 | 0.53 |
| Percent | 1.7391% | 3.9841% | 2.0156% |

Clearly, the precision of the system is a practical 99.9% even for Brix, the worst case. No other apparatus is as effective as this for in-line control of these materials. It should be noted that the numerical results are numerical signatures of the fluids being monitored, based on measured irradiance and are not in one-to-one correspondence with density or the like. These variables are calibrated empirically and have been shown to characterize these fluids for the quality control thereof. The row in Table 7 labeled “Per Cent” is:

$$Per Cent = 100 \times \frac{High Limit - Low Limit}{\frac{High Limit + Low Limit}{2}}$$

or the range as a per cent of the average value for a good product. Remedial action is triggered if the high limit is exceeded or if the output fails to exceed the low limit.

If relative drift between the two light sensors is a paramount concern, a second embodiment may be used. Referring to FIG. 2, the mechanical monitor is similar to that previously described, except that the armored cable 38 contains a fiber optic light guide rather than the power and signal leads previously described. In this case, a single light sensor is used. Housing 36 contains the light source and means to alternately direct light that comes directly from the light source, the reference light and to alternately direct light that has passed through the fluid being monitored, the quality light onto a single photo sensor. In this embodiment, the concern that one photosensor may drift between calibrations with respect to the other photosensor so that a error is made by generating an alert signal when the fluid is conforming or failing to generate an alert signal when the fluid is out of conformance. This embodiment requires that the light from at least one source be periodically occluded. Either the light sensor responds to one light at a time or one light at one time and the sum at another. In order for this embodiment to improve the situation, the occluding means must not introduce error.

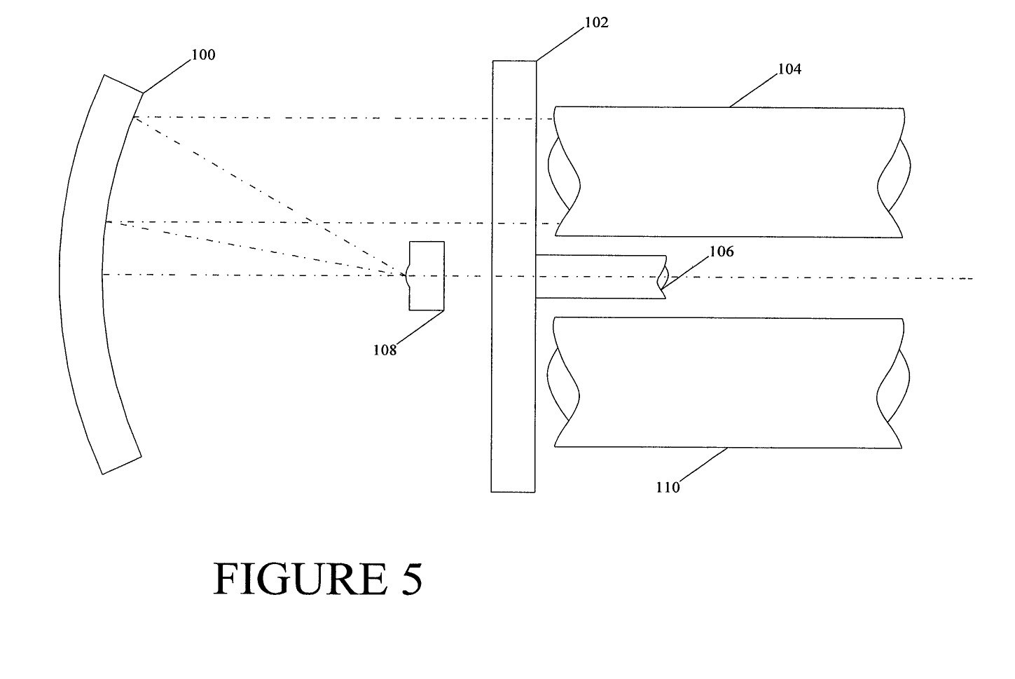

FIG. 5 is a schematic diagram of mechanical realization. In this embodiment, the two light detectors are replaced by an assembly that consists of a parabolic front surface mirror 100, a rotatable occluder 102, an electric motor (not shown) and a single light detector 108. Light that is monitoring the light source directly, i.e., the reference light, is directed by the upper fiber optic light guide 104 so that the axis of the light guide is parallel to the optical axis of the parabolic mirror. Light that passes through the fluid being monitored, i.e., quality light, is directed by the lower fiber optic light guide 110 so that the axis of the light guide is parallel to the optical axis of the parabolic mirror. The occluder 102 has alternating opaque and transparent regions such that a transparent region is maximally aligned with the light that passes through the fluid being monitored when an opaque region is maximally aligned with the light that passes through the attenuator, and vice versa.

Operation of the system is as follows. Light from either fiber optic light guide emerges from the guide substantially collimated. The substantially collimated light rays are substantially orthogonal to the occluder 102 and the axis of the parabolic reflector 100. Light is transmitted, partially transmitted or occluded depending on the angular position of the occluder. Transmitted or partially occluded light strikes the surface of the parabolic reflector. The surface of the reflector may be coated with a thin layer of aluminum then coated by a thin layer of magnesium fluoride. The per cent of light reflected by such a coating varies from 70 to 92 depending over a wavelength range of 200 nm to 2000 nm. Therefore, the reflector is suitable for all the light emitters contemplated in this invention. Because the surface is parabolic, the light will be substantially focused at the focus of the parabola. The other dimension of the reflector is circular. A light sensor 108 that may be any of the previous mentioned types is mounted such that the focused light is received by the sensor. The occluder has a shaft 106 at the center driven by a motor (not shown). The motor may operate continuously. With continuous operation, the light sensed has a peak value of one polarity when the light that passes through the fluid being monitored is maximally transmitted and a peak value of the other polarity when the light that passes through the fluid being monitored is maximally occluded.

The sensed light must be processed into the required reference signal sequence and quality signal sequence. This can be done in any of the methods previously described. Clearly, the properties of the light sensor and light emitter do not enter the relation unless either device is inoperative. It should be noted that the parabolic reflector 100 is one of several alternatives available. If a single light emitter is used, there is no technical reason to prefer the parabolic reflector to a refractive (lens) solution. In addition, a diffractive solution that combines the occluder and the focusing function can be realized by designing a rotating hologram.

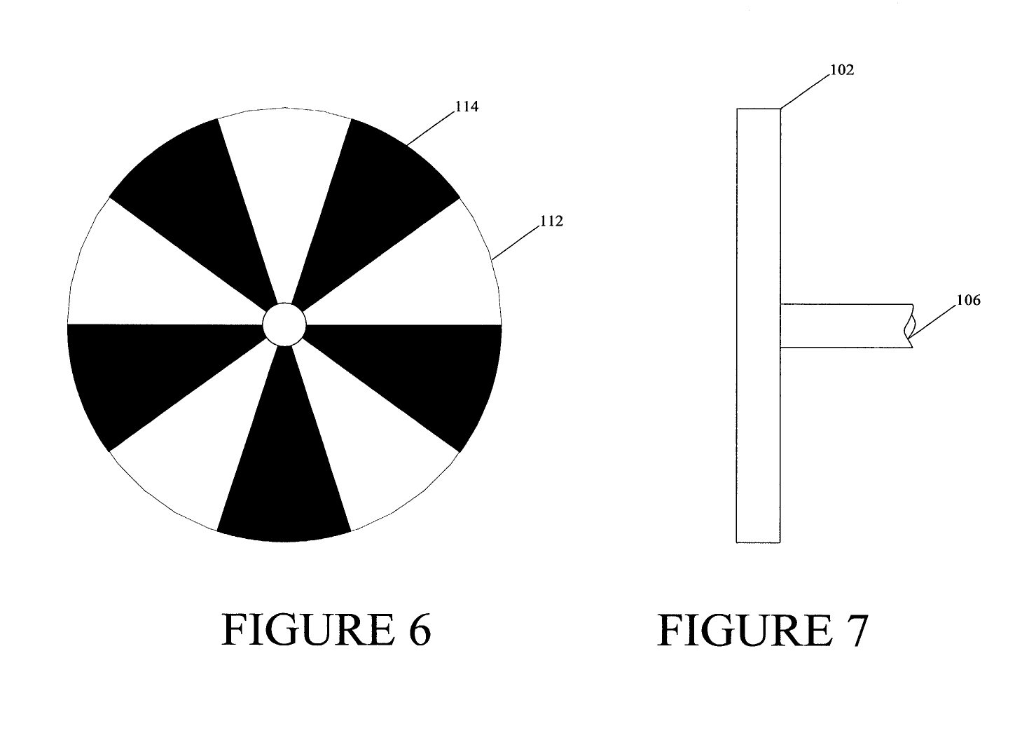

Another method of operation is to drive the shaft with a stepping motor. The motor rotates the shaft from fluid being monitored to reference alignment. This places the light sensor under computer control and the reference sampling rate may be “as needed.” If the occluding segments are as illustrated in FIGS. 6 and 7, the rotation per step is 36°.

Referring now to FIG. 6 and 7, some details of the occluder 102 are shown. In this specific illustration, a 36° transparent wedge 112 alternates with a 36° opaque area 114. Wedge arrangements that satisfy “180/(2n+1)=an integer” can be used if n=0, 1, 2, . . . ; here, n=2.

A Faraday rotator consists of a material with the ability to polarize light differently depending on the applied magnetic field. A Faraday rotator and appropriate polarizers may be used instead of the electromechanical method described above. The advantage of an all electronic solution is that moving parts may be subject to wear or sensitive to vibration. Occluders based on Faraday rotation are commercially available. Because the fluid being monitored can polarize the radiance passing through it, it is best to occlude only the light that does not pass through the fluid, the reference light. The sensor then alternately receives the sum of the reference signal and the quality signal and alternately the quality signal alone. The two signals may be readily separated in software.

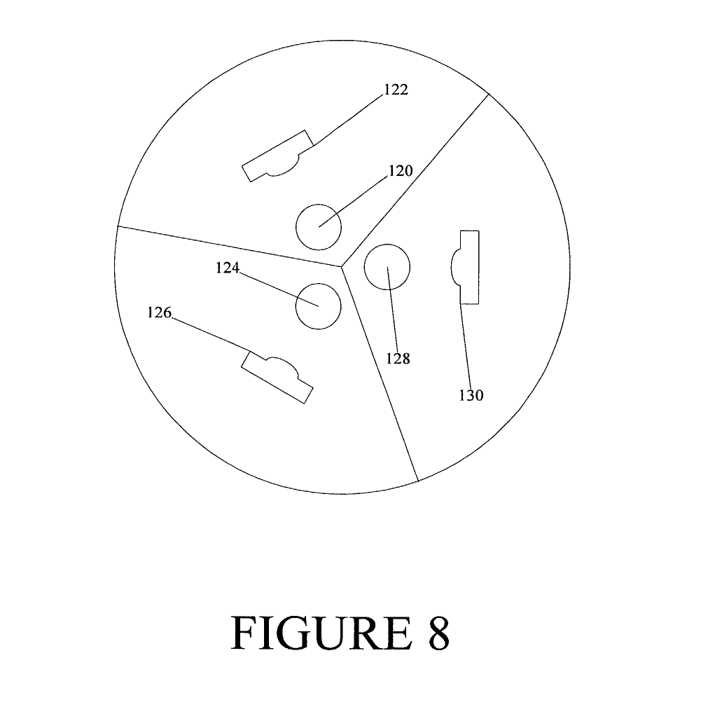

As shown in FIG. 2, the light source and reference sensor are packaged in housing 32. In a further embodiment of the invention, the single light emitter and single light sensor may be replaced with a plurality of light emitters and a plurality of light sensors. FIG. 8 shows a section of housing 32. In the first embodiment, this section would show a central light emitter and a light-to-frequency converter for sensing the light directly and developing the reference signal. For the purposes of illustration, three emitter-sensor pairs are shown. Emitter 120 may be a light-emitting diode with an output wavelength selected from the list given in Table 6. Light-to-frequency converter 122 is paired with this emitter. Converters such as the Texas Instruments TSL235® have broadband light sensitivity and can be successfully operated with any of the emitters on the list. Emitter 124 may be a light-emitting diode with an output wavelength selected from the list given in table 6 but differing from the wavelength associated with emitter 120. The sensor associated with emitter 124 is sensor 126. Similarly, emitter 128 differs from emitter 120 and differs from emitter 124 and has associated sensor 130. Three emitters are illustrated, but clearly the concept may be implemented with two or more emitter-sensor pair. Furthermore, physical arrangements in which two emitters share a sensor may be employed. With this embodiment, the fluid is illuminated by one emitter at a time. A reference signal is established for each emitter. A unique quality signal is established for each emitter. This is easily accomplished if the decision and display function is implemented in a computer. With a known conforming fluid, limits are established for each wavelength. Alert signals may now be based on “fuzzy-logic” algorithms such as weighted majority decisions.

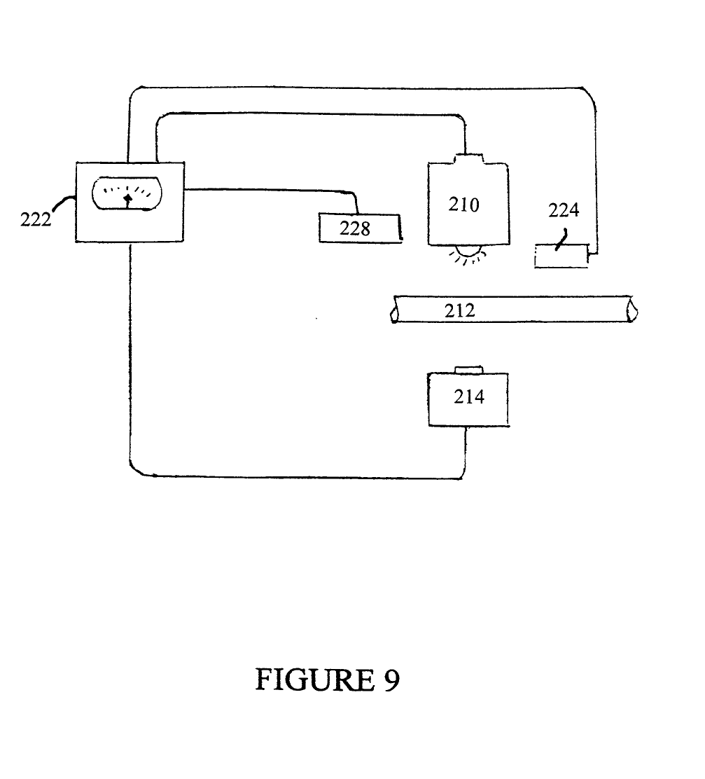

Referring to FIG. 9, which is a simplified schematic diagram of the invention, a source of a beam of light, sound or any desired ray, such as an x-ray or gamma ray 210 is directed toward any fluid 212 or other material to be monitored. A sensor 214 is positioned opposite the light source 210 with the material 212 being monitored located between the light source and the sensor 214, which detects the light passing through the material. A measurement device 222 detects any incremental change in the amount of light received by the sensor and warns the operator of a change in the detected light transmitted.

Recognizing that there may be some fluctuation in the light being transmitted, an additional sensor 224 may be located near the light source 210 to determine any fluctuation in light emanating from the light source. This amount of change is immediately transmitted to the measurement device 222, which adjusts the reading accordingly. In the event that the material 212 is opaque or nearly so, another sensor 228 may be positioned to read the reflected beam of light, immediately transmitting the reading to the measurement device. Any change in the reflected beam being detected will change the readout of device 222 and warn the operator of the change.

### SUMMARY OF THE ACHIEVEMENT OF THE OBJECTS OF THE INVENTION

From the foregoing it is readily apparent that I have invented an apparatus and method for the monitoring of fluids in an in-line processing plant for such fluid, for example carbonated beverage bottling, that captures sufficient salient data concerning qualities of the fluid for control of the quality of such fluid.

It is to be understood that the foregoing description and specific embodiments are merely illustrative of the best mode of the invention and the principles thereof, and that various modifications and additions may be made to the apparatus by those skilled in the art, without departing from the spirit and scope of this invention, which is therefore understood to be limited only by the scope of the appended claims.

What is claimed is:

1. A method of monitoring a fluid for conformance to a predetermined specification comprising the steps of:
a. directing a beam of light toward said fluid and passing a portion of said beam through said fluid;
b. establishing a reference signal from said beam of light that is independent of said fluid;
c. establishing a quality signal from the fraction of said beam of light that passes through said fluid and is characteristic thereof;
d. determining an upper limit and a lower limit by characterizing said quality signal with a known conforming fluid;
e. continuously monitoring said reference signal;
f. continuously monitoring said quality signal;
g. generating a first alert signal if said reference signal changes more than a predetermined amount, and
h. generating a second alert signal if said quality signal exceeds said upper limit or is less than said lower limit.

2. A method of monitoring a beverage bottling plant according to claim 1 wherein water and syrup are mixed and the mixture gasified, comprising:
a. monitoring the plant water;
b. monitoring the syrup;
c. monitoring the mixture of plant water and syrup;
d. adjusting the upper and lower limit of the quality signal for the mixture of water and syrup according to the quality signal for the water and according to the quality signal for the syrup;
e. monitoring the gasified water and syrup mixture;
f. adjusting the upper and lower limit of the quality signal for the gasified water and syrup mixture according to the quality signal for the water and syrup mixture;
g. generating a plurality of first alert signals if the corresponding reference signals change more than a predetermined amount, and
h. generating a plurality of second alert signals if the corresponding quality signals exceed their respective upper limits or are less than their respective lower limits.

3. Apparatus for monitoring a fluid, comprising:
a. a narrow band light source;
b. an inert pipe through which a fluid of interest flows;
c. said inert pipe fitted having a tee-section with windows to admit light passing through a first window, through the fluid of interest and exiting through a second window;
d. a first sensor mounted to receive light from said narrow band light source for determining the magnitude thereof independent of said fluid;
e. a second sensor mounted to receive light that has passed through said fluid of interest;
f. means for generating a sequence of reference signals by continuously determining the quantity of light received by said first sensor over a first fixed period of time;
g. means for generating a sequence of quality signals by continuously determining the quantity of light received by said second sensor over said first period of time;
h. means for calibrating said apparatus comprising:
means for storing a calibration value for said reference signals;
means for storing the maximum values for said quality signals when a known
conforming fluid is present, and
means for storing minimum values for said quality signals when a known conforming fluid is present;
i. means for generating an alert signal whenever the reference signal deviates from said calibration value by more than a predetermined amount, and
j. means for generating an alert signal whenever said quality signal exceed the maximum value that corresponds to said quality signal or is less than the minimum value that corresponds to said quality signal.

4. Apparatus according to claim 3 wherein said narrow band light source is selected from the group consisting of: light-emitting diodes, solid state lasers and gas discharge lamps.

5. Apparatus according to claim 3 wherein said first sensor and said second sensor are selected from the group consisting of: photodiodes, phototransistors and photosensitive integrated circuits.

6. Apparatus according to claim 5 wherein said first sensor and said second sensor consist of a light-to-frequency converter, whereby the frequency of said converter depends on the magnitude of the irradiance on the photodiode area thereof.

7. Apparatus according to claim 3 wherein the apparatus for determining the quantity of light received by a sensor over a first period of time consists of an integrator followed by an analog to digital converter.

8. Apparatus according to claim 3 wherein the apparatus for determining the quantity of light received by a sensor over a first period of time consists of a counter for counting pulses from a light-to-frequency convert for said first period of time.

9. Apparatus for monitoring a fluid, comprising:
a. a narrow band light source;
b. an inert pipe through which a fluid of interest flows;
c. a tee-section of said inert pipe fitted with windows to admit light passing through a first window, through the fluid of interest and exiting through a second window;
d. means to alternately direct light from said narrow band light source for determining the magnitude thereof independent of said fluid and alternately direct light that has passed through said fluid of interest to a single sensor;
e. means for generating a sequence of reference signals by continuously determining the quantity of light received by said sensor when said sensor is in optical communication with said independent light over a first fixed period of time;
f. means for generating a sequence of quality signals by continuously determining the quantity of light received by said sensor when said sensor is in optical communication with said dependent light over said first period of time;
g. means for calibrating said apparatus comprising:
means for storing a calibration value for said reference signals;
means for storing the maximum value for said quality signal when a known conforming fluid is present, and
means for storing minimum value for said quality signal when a known conforming fluid is present;
h. means for generating an alert signal whenever said reference signal deviates from said calibration value by more than a predetermined amount, and
i. means for generating an alert signal whenever said quality signal exceeds said maximum value or is less than said minimum value.

10. Apparatus according to claim 9 further comprising mechanical shuttering means wherein the light from the narrow band light source and the light that has passed through the fluid of interest are alternately directed to said sensor.

11. Apparatus according to claim 9 further comprising electronic shuttering means by which the light from the narrow band light source and the light that has passed through the fluid of interest are alternately directed to said sensor.

12. Apparatus according to claim 13 wherein the electronic shuttering means consists of at least one Faraday rotator and appropriate polarizers.

13. Apparatus for monitoring a fluid comprising:
a. a plurality of narrow band light sources;
b. an inert pipe through which a fluid of interest flows;
c. a tee-section of said inert pipe fitted with windows to admit light passing through a first window, through the fluid of interest and exiting through a second window;
d. commutating means to sequentially select each of said plurality of light sources;
e. a plurality of reference light sensors mounted to receive light from said plurality of narrow band light sources for determining the magnitudes thereof independent of said fluid;
f. a quality light sensor mounted to receive light that has passed through said fluid of interest;
g. means for generating plurality of sequences of reference signals by continuously determining the quantity of light received by said plurality of said reference light sensors over a first fixed period of time;
h. means for generating a sequence of quality signals by continuously determining the quantity of light received by said quality light sensor over said first period of time;
i. means for calibrating said apparatus comprising:
a plurality of means for storing a calibration values for each of said reference signals;
means for storing a plurality of maximum values for each of said quality signals when a known conforming fluid is present and a known light source is active, and
means for storing a plurality of minimum values for each of said quality signals when a known conforming fluid is present and a known light source is active;
j. means for generating a plurality of alert signals whenever said plurality of reference signals deviate from said plurality of calibration values by more than a plurality of respective predetermined amounts, and
k. means for generating an alert signal whenever any of said plurality of quality signals exceed the corresponding maximum value or is less than the corresponding minimum value.
